(19) United States
(12) Patent Application Publication
(10) Pub. No.: US 2022/0314310 A1
(43) Pub. Date: Oct. 6, 2022

(54) INSPECTION METHOD FOR CASTING MOLD, AND CASTING DEVICE

(71) Applicant: HONDA MOTOR CO., LTD., Tokyo (JP)

(72) Inventors: Kenji Yuki, Tokyo (JP); Satoru Kimura, Tokyo (JP); Ryo Onishi, Tokyo (JP)

(21) Appl. No.: 17/681,936

(22) Filed: Feb. 28, 2022

(30) Foreign Application Priority Data
Mar. 31, 2021 (JP) 2021-062109

(51) Int. Cl. B22D 18/08; B22D 18/06

(52) U.S. Cl. CPC B22D 18/08; B22D 18/06

(57) ABSTRACT

A casting mold includes a cavity portion, a gas flow path, and a shut-off valve capable of blocking the gas flow path. An inspection method for the casting mold includes: a step of, when the casting mold is cold, supplying air having a predetermined pressure into the gas flow path while the shut-off valve is closed, and thereafter stopping supply of the air; a step of acquiring a cold time pressure reduction rate of the air in the gas flow path after the supply of the air is stopped; and a step of determining whether the cold time sealing performance of the shut-off valve is good, based on the cold time pressure reduction rate.

### CROSS-REFERENCE TO RELATED APPLICATIONS

This application is based upon and claims the benefit of priority from Japanese Patent Application No. 2021-062109 filed on Mar. 31, 2021, the contents of which are incorporated herein by reference.

### BACKGROUND OF THE INVENTION

### Field of the Invention

The present invention relates to an inspection method for a casting mold, and to a casting device.

### Description of the Related Art

Vacuum casting systems are known (for example, JP H10-249509 A). In the vacuum casting system, molten metal is injected into a cavity after gas in the cavity is sucked. This can reduce defects (for example, blow holes) of a cast product due to mixing of the gas into the molten metal. A casting mold for a vacuum casting system has a shut-off valve for releasing a connection between a cavity and a suction path for sucking gas when molten metal is injected into the cavity.

Here, the sealing performance of the casting mold itself and the shut-off valve is not always satisfactory. For example, due to casting, the sealing performance may vary due to uneven wear of the sealing surface and the trapping of burrs by the shut-off valve. Further, the accumulation of foreign matter in the suction path reduces the gas permeability of the suction path.

It is not always easy to efficiently and reliably inspect whether such sealing performance is good.

### SUMMARY OF THE INVENTION

It is a task to efficiently and reliably inspect the sealing performance of a shut-off valve for blocking the suction path of a casting mold. An object of the present invention is to achieve this task.

According to an aspect of the present invention, there is provided an inspection method for a casting mold, the casting mold comprising: a gas flow path including a first end which is one end connected to a cavity portion formed in the casting mold; and a shut-off valve configured to allow the gas flow path to be blocked, the inspection method comprising: a step of, when the casting mold is cold, supplying air having a predetermined pressure into the gas flow path from a second end which is another end of the gas flow path while the shut-off valve is closed, and thereafter stopping supply of the air; a step of acquiring a cold time pressure reduction rate of the air in the gas flow path after the supply of the air is stopped when the casting mold is cold; and a step of determining whether a cold time sealing performance of the shut-off valve is good, based on the cold time pressure reduction rate.

According to another aspect of the present invention, there is provided a casting device comprising: a casting mold including a cavity portion, a gas flow path including a first end which is one end connected to the cavity portion, and a shut-off valve configured to allow the gas flow path to be blocked; an air supply unit configured to supply air having a predetermined pressure into the gas flow path from a second end which is another end of the gas flow path; and a control unit configured to control the air supply unit and the shut-off valve, wherein when the casting mold is cold, the control unit controls the shut-off valve and the air supply unit to supply the air having the predetermined pressure into the gas flow path from the second end of the gas flow path while the shut-off valve is closed and thereafter stop supply of the air, acquires a cold time pressure reduction rate of the air in the gas flow path after the supply of the air is stopped when the casting mold is cold, and determines whether a cold time sealing performance of the shut-off valve is good, based on the cold time pressure reduction rate.

According to the present invention, it is possible to provide an inspection method for a casting mold, and a casting device that are capable of efficiently and reliably inspecting the sealing performance of the shut-off valve for blocking the suction path of the casting mold.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a view showing a casting device according to an embodiment of the present invention;

FIG. 2 is a flow chart showing an inspection method for a casting mold according to the embodiment of the present invention;

FIG. 3 is a flow chart showing the details of a step of inspecting a cold time sealing performance;

FIG. 4 is a flow chart showing the details of a step of inspecting the gas permeability; and

FIG. 5 is a flow chart showing the details of a step of inspecting a hot time sealing performance.

### DESCRIPTION OF THE INVENTION

Hereinafter, an inspection method for a casting mold, and a casting device according to an embodiment of the present invention will be described.

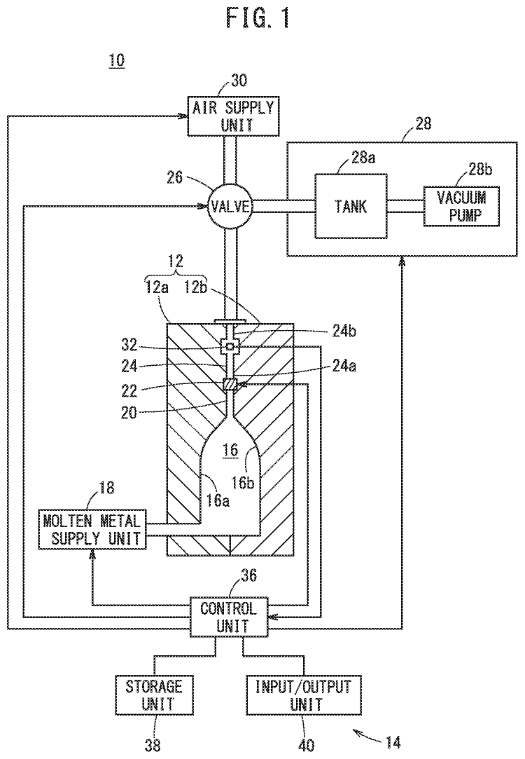

A casting device 10 shown in FIG. 1 includes a casting mold 12 and an inspection device 14 for inspecting the casting mold 12. The casting mold 12 includes a fixed mold 12a and a movable mold 12b which face each other in the left-right direction (horizontal direction) of the drawing. The movable mold 12b moves in the horizontal direction so as to be able to contact and separate from the fixed mold 12a. The fixed mold 12a and the movable mold 12b have mating surfaces facing each other. The mating surface of the fixed mold 12a and the mating surface of the movable mold 12b have a concave portion 16a and a concave portion 16b, respectively. The concave portion 16a and the concave portion 16b form a cavity portion 16. By bringing the movable mold 12b into contact with the fixed mold 12a, the casting mold 12 is closed. As a result, the cavity portion 16 is formed inside the casting mold 12.

A molten metal supply unit 18 is connected to the casting mold 12. The molten metal supply unit 18 is attached to the fixed mold 12a and supplies molten metal into the cavity portion 16. The movable mold 12b includes an overflow portion 20 downstream of the cavity portion 16. The molten metal supplied to the cavity portion 16 reaches the overflow portion 20. Thereafter, the molten metal solidifies inside the cavity portion 16 and the overflow portion 20. The solidified molten metal is taken out from the casting mold 12 as a cast product.

The casting mold 12 includes a shut-off valve 22 and a suction path 24 (gas flow path). The shut-off valve 22 is disposed between the overflow portion 20 and the suction path 24. The shut-off valve 22 prevents the molten metal from flowing from the overflow portion 20 into the suction path 24 by blocking the suction path 24.

The suction path 24 is connected to a gas suction unit 28 through a valve 26. The suction path 24 has an end portion 24a (first end as one end) connected to the cavity portion 16 and an end portion 24b (second end as another end) connected to the gas suction unit 28. The gas suction unit 28 sucks gas in the cavity portion 16 through the valve 26, the suction path 24, and the overflow portion 20. The gas suction unit 28 includes a tank 28a and a vacuum pump 28b. The gas suction unit 28 sucks the gas in the cavity portion 16 by the tank 28a depressurized by the vacuum pump 28b. By sucking the gas in the cavity portion 16 by the gas suction unit 28 before supplying the molten metal into the cavity portion 16, defects (for example, blow holes) of the cast product due to the mixing of the gas into the molten metal can be reduced.

The gas suction unit 28 and an air supply unit 30 are connected to the valve 26. The air supply unit 30 feeds air into (air-blows) the casting mold 12 in an open state, through the valve 26, the suction path 24, and the overflow portion 20. The air supplied from the air supply unit 30 to the end portion 24b (second end) of the suction path 24 cleans the suction path 24, the shut-off valve 22, and the like. The valve 26 switches the connection between the suction path 24 and the gas suction unit 28 and the connection between the suction path 24 and the air supply unit 30.

A pressure detector 32 is disposed in the suction path 24. The pressure detector 32 detects the pressure of gas in the suction path 24. The pressure of the gas in the suction path 24 varies depending on the suction of the gas by the gas suction unit 28 and the supply of the air from the air supply unit 30.

The inspection device 14 includes a control unit 36, a storage unit 38, and an input/output unit 40. The inspection device 14 inspects the casting mold 12 including the shut-off valve 22. The control unit 36 includes hardware (for example, a processor) and software (for example, a program). The control unit 36 controls the molten metal supply unit 18, the shut-off valve 22 (a valve element and a valve seat), the valve 26, the gas suction unit 28, and the air supply unit 30. Further, the control unit 36 receives signals from the pressure detector 32. The storage unit 38 is, for example, a hard disk or a semiconductor memory. The storage unit 38 stores a first threshold T1a and a second threshold T1b which will be described later. The input/output unit 40 is a device for inputting/outputting information between the control unit 36 and an operator, and is a keyboard and a display device, for example.

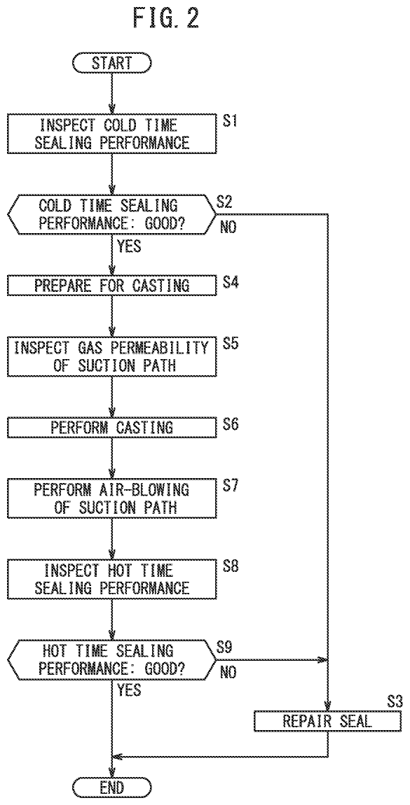

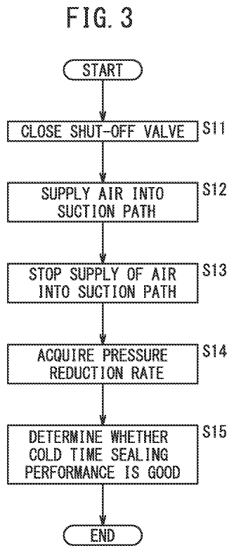

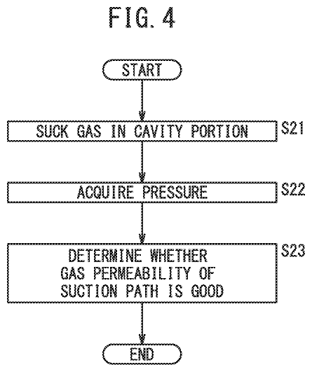

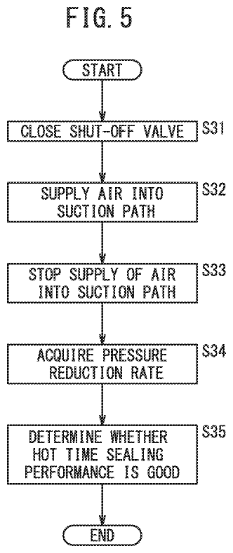

FIG. 2 is a flow chart showing an inspection method for the casting mold 12 according to the embodiment. The inspection method includes steps (step S1 and step S8) of inspecting the sealing performance of the shut-off valve 22, and a step (step S5) of inspecting the gas permeability of the suction path 24. FIG. 3 and FIG. 5 are flow charts showing the details of steps of inspecting a cold time sealing performance and a hot time sealing performance. FIG. 4 is a flow chart showing the details of a step of inspecting the gas permeability. Hereinafter, the inspection method for the casting mold 12 will be described with reference to FIGS. 2 to 5.

The state of the casting mold 12 differs between cold time and hot time. Here, the cold time (cold state) refers to a time (state) in which the temperature of the casting mold 12 is close to the room temperature. If the casting mold 12 is not being used for casting, or if sufficient time has elapsed since the casting mold 12 was used for casting, the casting mold 12 is in the cold state. The temperature of the casting mold 12 in the cold state is a normal temperature, for example, 0 to 50° C. In the cold state, the difference in thermal expansion or the like between the members constituting the casting mold 12 does not significantly affect the sealing performance of the casting mold 12. On the other hand, the hot time (hot state) refers to a time (state) in which the temperature of the casting mold 12 is much higher than the room temperature. If not much time has elapsed since the casting mold 12 was used for casting, the casting mold 12 is in the hot state. The temperature of the casting mold 12 in the hot state is, for example, 50 to 400° C. In the hot state, the difference in thermal expansion or the like between the members of the casting mold 12 can greatly affect the sealing performance of the casting mold 12.

In the present embodiment, the cold time sealing performance is inspected first (step S1 in FIG. 2 and steps S11 to S15 in FIG. 3). First, when the casting mold 12 is cold, the control unit 36 controls the shut-off valve 22 to close the shut-off valve 22 (step S11). Next, the control unit 36 controls the air supply unit 30 to supply air having a predetermined pressure P0 from the air supply unit 30 into the suction path 24 in a state where the shut-off valve 22 is closed (step S12). Thereafter, the control unit 36 controls the air supply unit 30 to stop the supply of the air (step S13). The predetermined pressure P0 can be selected from a pressure range (for example, 300 to 500 kPa) sufficiently greater than atmospheric pressure (about 101 kPa).

The control unit 36 acquires a cold time pressure reduction rate V1a of the air in the suction path 24 after the supply of air is stopped (step S14). The cold time pressure reduction rate Via can be acquired, for example, in the following manner. First, the control unit 36 uses the pressure detector 32 to measure the pressure in the suction path 24 after a predetermined time Δt has elapsed since the supply of the air was stopped. Next, the control unit 36 calculates the cold time pressure reduction rate V1a, based on a difference ΔP (=P0−P1) between the predetermined pressure P0 and a pressure P1 measured when the casting mold 12 is cold. The cold time pressure reduction rate V1a can be calculated using an expression V1a=ΔP/Δt.

The control unit 36 determines whether the cold time sealing performance of the casting mold 12 itself and the shut-off valve 22 is good, based on the cold time pressure reduction rate V1a, and displays the result of the determination on the input/output unit 40 (step S15). The fact that the cold time pressure reduction rate V1a is not 0 means that the shut-off valve 22 has some leakage (that is, the sealing performance of the shut-off valve 22 is not perfect). The control unit 36 compares the absolute value of the cold time pressure reduction rate V1a with a first threshold T1a, and determines whether the cold time sealing performance is good based on the result of the comparison. Specifically, when the absolute value of the cold time pressure reduction rate V1a is equal to or less than the first threshold T1a, the control unit 36 determines that the cold time sealing performance is good. When the absolute value of the cold time pressure reduction rate V1a is greater than the first threshold T1a, the control unit 36 determines that the cold time sealing performance is poor.

When the control unit 36 determines that the cold time sealing performance is poor, the seal of the shut-off valve 22 is repaired (“NO” in step S2 and step S3). For example, it is checked whether foreign matter adheres to the mating surface of the casting mold 12, or the valve element (valve head) or the valve seat of the shut-off valve 22. If foreign matter adheres, the foreign matter is removed.

When it is determined that the cold time sealing performance is good (“YES” in step S2), preparation for casting is performed (step S4). That is, the casting mold 12 is preliminarily heated by, for example, preheating shot. The preheating shot refers to casting and removal of the cast product for the purpose of heating the casting mold 12. As a result of the preliminary heating, the casting mold 12 transitions from the cold state to the hot state. Thereafter, the gas permeability of the suction path 24 in the hot state is inspected (step S5). In the vacuum casting, the gas in the cavity portion 16 is sucked by the gas suction unit 28 before casting. Using this suction step, the gas permeability of the suction path 24 can be inspected.

The gas permeability of the suction path 24 represents the ease with which the gas passes through the suction path 24. The gas permeability of the suction path 24 is reduced due to, for example, clogging of the suction path 24 caused by the accumulation of foreign matter. The inspection of the gas permeability of the suction path 24 is performed in accordance with the procedure shown in FIG. 4. First, when the casting mold 12 is hot, the control unit 36 controls the gas suction unit 28 and the shut-off valve 22 to open the shut-off valve 22. That is, the control unit 36 causes the gas suction unit 28 to start sucking the gas in the cavity portion 16. Next, the control unit 36 controls the shut-off valve 22 to close the shut-off valve 22 after a predetermined time has elapsed from the start of suction (step S21). The pressure detector 32 acquires the pressure P of the gas in the suction path 24 at the time when the shut-off valve 22 is closed (step S22). Then, based on the pressure P, the control unit 36 determines whether the gas permeability of the suction path 24 is good. When the pressure P is equal to or less than a predetermined value, the control unit 36 determines that the gas permeability of the suction path 24 is good. When the pressure P is greater than the predetermined value, the control unit 36 determines that the gas permeability of the suction path 24 is poor (step S23).

After the inspection of the gas permeability (step S5), casting is performed (step S6). That is, casting itself is performed regardless of whether or not the gas permeability of the suction path 24 is good. It should be noted that, when the gas permeability of the suction path 24 is poor, maintenance work is performed after the cast product is taken out from the casting mold 12 and before the next casting is performed. The maintenance work is, for example, cleaning of the suction path 24.

The control unit 36 controls the molten metal supply unit 18 to supply molten metal into the cavity portion 16. Thus, casting is performed (step S6). As a result of casting, the solidified molten metal is taken out as a cast product. Thereafter, the control unit 36 controls the air supply unit 30 to supply air from the air supply unit 30 into the suction path 24 in a state where the shut-off valve 22 is opened. That is, the control unit 36 causes the suction path 24 to be air-blown (step S7). If foreign matter flows into the suction path 24 at the time of casting, the foreign matter that has not stuck in the suction path 24 can be removed from the suction path 24 by air blowing. Note that the air blowing may be performed in the step of preparing for casting (step S4). In general, cleaning of the casting mold 12 is performed at the stage of preparation for casting. Air blowing can be performed at the time of cleaning. In this manner, in the step of preparing for casting (step S4), air blowing for the suction path 24 is performed. That is, prior to the inspection of the gas permeability of the suction path 24, air blowing is performed to remove the foreign matter that has not stuck in the suction path 24. As a result, it is possible to improve the accuracy of the inspection of the gas permeability of the suction path 24.

The control unit 36 inspects the hot time sealing performance (step S8 in FIG. 2 and steps S31 to S35 in FIG. 5). Actually, the inspection of the hot time sealing performance goes through a different process from that for the inspection of the cold time sealing performance, but the inspection of the hot time sealing performance is partially similar to the inspection of the cold time sealing performance. First, when the casting mold 12 is hot, the control unit 36 controls the shut-off valve 22 and the air supply unit 30 to close the shut-off valve 22 (step S31). Next, the control unit 36 controls the air supply unit 30 to supply air having the predetermined pressure P0 into the suction path 24 (step S32). Thereafter, the control unit 36 stops the supply of the air (step S33). The control unit 36 acquires a hot time pressure reduction rate V1b of the air in the suction path 24 after the supply of the air is stopped in the hot state (step S34). The control unit 36 determines whether the hot sealing performance of the casting mold 12 itself and the shut-off valve 22 is good, and displays the result of the determination on the input/output unit 40 (step S35). The control unit 36 compares the absolute value of the hot time pressure reduction rate V1b with a second threshold T1b, and determines whether the hot time sealing performance is good based on the result of the comparison. Specifically, when the absolute value of the hot time pressure reduction rate V1b is equal to or less than the second threshold T1b, the control unit 36 determines that the hot time sealing performance is good. When the absolute value of the hot time pressure reduction rate V1b is greater than the second threshold T1b, the control unit 36 determines that the hot time sealing performance is poor. When the control unit 36 determines that the hot time sealing performance is poor, the seal of the shut-off valve 22 is repaired (“NO” in step S9 and step S3).

Here, the second threshold T1b for determining the hot time sealing performance is greater than the first threshold T1a for determining the cold time sealing performance. This is because the cold time sealing performance and the hot time sealing performance are different from each other due to the thermal expansion of the casting mold 12 (particularly the difference in thermal expansion between the members of the casting mold 12). For example, the first threshold T1a can be set to 5 kPa/sec, and the second threshold T1b can be set to a value in the range of 20 kPa/sec to 40 kPa/sec. The second threshold T1b is preferably changed in accordance with the predetermined pressure P0 of the air supplied from the air supply unit 30 into the suction path 24. For example, when the predetermined pressure P0 is 350 kPa to 400 kPa, the second threshold T1b can be set to 27 kPa/sec. These are merely examples, and the thresholds differ depending on the pressure of the factory air or the specifications of equipment. Except for the above features, the inspection of the hot time sealing performance is the same as the inspection of the cold time sealing performance, and a detailed description thereof is omitted.

As described above, in the present embodiment, it is possible to inspect the cold time sealing performance, the hot time sealing performance, and the gas permeability of the suction path 24 in the hot state.

[Invention Obtained from Embodiment]

The invention that can be grasped from the above embodiment will be described below.

[1] An inspection method for a casting mold (12), the casting mold comprising: a gas flow path (suction path 24) including a first end (end portion 24a) which is one end connected to a cavity portion (16) formed in the casting mold; and a shut-off valve (22) configured to allow the gas flow path to be blocked, the inspection method comprising: a step of, when the casting mold is cold, supplying air having a predetermined pressure (P0) into the gas flow path from a second end (end portion 24b) which is another end of the gas flow path while the shut-off valve is closed (step S12), and thereafter stopping supply of the air (step S13); a step (step S14) of acquiring a cold time pressure reduction rate (V1a) of the air in the gas flow path after the supply of the air is stopped when the casting mold is cold; and a step (step S15) of determining whether a cold time sealing performance of the shut-off valve is good, based on the cold time pressure reduction rate. As a result, it is possible to determine the cold time sealing performance based on the cold time pressure reduction rate.

[2] The inspection method further comprises a step of, when the casting mold is hot, supplying the air having the predetermined pressure from the second end of the gas flow path into the gas flow path while the shut-off valve is closed (step S32), ant thereafter stopping supply of the air (step S33), a step (step S34) of acquiring a hot time pressure reduction rate (V1b) of the air in the gas flow path after the supply of the air is stopped when the casting mold is hot, and a step (step S35) of determining whether a hot time sealing performance of the shut-off valve is good, based on the hot time pressure reduction rate. Thus, it is possible to determine whether the hot time sealing performance is good, based on the hot time pressure reduction rate.

[3] The inspection method further comprises a step (Step S7) of supplying air into the gas flow path and air-blowing the gas flow path in a state where the shut-off valve is opened, before a casting step performed when the casting mold is hot. This makes it possible to remove foreign matter that has not stuck in the gas flow path.

[4] The step of determining whether the cold time sealing performance is good comprises a step of comparing an absolute value of the cold time pressure reduction rate with a first threshold (T1a), determining that the cold time sealing performance is good when the absolute value of the cold time pressure reduction rate is equal to or less than the first threshold, and determining that the cold time sealing performance is poor when the absolute value of the cold time pressure reduction rate is greater than the first threshold. The step of determining whether the hot time sealing performance is good comprises a step of comparing an absolute value of the hot time pressure reduction rate with a second threshold (T1b), determining that the hot time sealing performance is good when the absolute value of the hot time pressure reduction rate is equal to or less than the second threshold, and determining that the hot time sealing performance is poor when the absolute value of the hot time pressure reduction rate is greater than the second threshold, the second threshold being greater than the first threshold. Thus, by making the second threshold for the hot time greater than the first threshold for the cold time, it is possible to appropriately evaluate the sealing performance both in the cold time and hot time.

[5] The step of acquiring the cold time pressure reduction rate comprises a step of measuring a pressure in the gas flow path after a predetermined time has elapsed since the supply of the air is stopped when the casting mold is cold, and a step of calculating the cold time pressure reduction rate (V1a) based on a difference between the predetermined pressure and the pressure measured when the casting mold is cold. As a result, it is possible to appropriately acquire the cold time pressure reduction rate for determining the cold time sealing performance.

[6] The step of acquiring the hot time pressure reduction rate comprises a step of measuring a pressure in the gas flow path after a predetermined time has elapsed since the supply of the air is stopped when the casting mold is hot, and a step of calculating the hot time pressure reduction rate (V1b) based on a difference between the predetermined pressure and the pressure measured when the casting mold is hot. As a result, it is possible to appropriately acquire the hot time pressure reduction rate for determining the hot time sealing performance.

[7] A casting device (10) comprising: a casting mold including a cavity portion, a gas flow path including a first end which is one end connected to the cavity portion, and a shut-off valve configured to allow the gas flow path to be blocked; an air supply unit (30) configured to supply air having a predetermined pressure into the gas flow path from a second end which is another end of the gas flow path; and a control unit (36) configured to control the air supply unit and the shut-off valve, wherein, when the casting mold is cold, the control unit controls the shut-off valve and the air supply unit to supply the air having the predetermined pressure into the gas flow path from the second end of the gas flow path while the shut-off valve is closed and thereafter stop supply of the air, acquires a cold time pressure reduction rate of the air in the gas flow path after the supply of the air is stopped when the casting mold is cold, and determines whether a cold time sealing performance of the shut-off valve is good, based on the cold time pressure reduction rate. As a result, it is possible to determine whether the cold time sealing performance is good, based on the cold time pressure reduction rate.

[8] When the casting mold is hot, the control unit controls the shut-off valve and the air supply unit to supply the air having the predetermined pressure into the gas flow path from the second end of the gas flow path while the shut-off valve is closed, and thereafter stop supply of the air, acquires a hot time pressure reduction rate of the air in the gas flow path after the supply of the air is stopped when the casting mold is hot, and determines whether a hot time sealing performance of the shut-off valve is good, based on the hot time pressure reduction rate. As a result, it is possible to determine whether the hot time sealing performance is good, based on the hot time pressure reduction rate.

[9] When determining whether the cold time sealing performance is good, the control unit compares an absolute value of the cold time pressure reduction rate with a first threshold, and determines that the cold time sealing performance is good when the absolute value of the cold time pressure reduction rate is equal to or less than the first threshold, and determines that the cold time sealing performance is poor when the absolute value of the cold time pressure reduction rate is greater than the first threshold, and when determining whether the hot time sealing performance is good, the control unit compares an absolute value of the hot time pressure reduction rate with a second threshold, and determines that the hot time sealing performance is good when the absolute value of the hot time pressure reduction rate is equal to or less than the second threshold, and determines that the hot time sealing performance is poor when the absolute value of the hot time pressure reduction rate is greater than the second threshold, the second threshold being greater than the first threshold. Thus, by making the second threshold for the hot time greater than the first threshold for the cold time, it is possible to appropriately evaluate the sealing performance both in the cold time and hot time.

What is claimed is:

1. An inspection method for a casting mold,
the casting mold comprising:
a gas flow path including a first end which is one end connected to a cavity portion formed in the casting mold; and
a shut-off valve configured to allow the gas flow path to be blocked,
the inspection method comprising:
a step of, when the casting mold is cold, supplying air having a predetermined pressure into the gas flow path from a second end which is another end of the gas flow path while the shut-off valve is closed, and thereafter stopping supply of the air;
a step of acquiring a cold time pressure reduction rate of the air in the gas flow path after the supply of the air is stopped when the casting mold is cold; and
a step of determining whether a cold time sealing performance of the shut-off valve is good, based on the cold time pressure reduction rate.

2. The inspection method for the casting mold according to claim 1, further comprising:
a step of, when the casting mold is hot, supplying the air having the predetermined pressure from the second end of the gas flow path into the gas flow path while the shut-off valve is closed, ant thereafter stopping supply of the air;
a step of acquiring a hot time pressure reduction rate of the air in the gas flow path after the supply of the air is stopped when the casting mold is hot; and
a step of determining whether a hot time sealing performance of the shut-off valve is good, based on the hot time pressure reduction rate.

3. The inspection method for the casting mold according to claim 2, further comprising a step of supplying air into the gas flow path and air-blowing the gas flow path in a state where the shut-off valve is opened, before a casting step performed when the casting mold is hot.

4. The inspection method for the casting mold according to claim 2, wherein
the step of determining whether the cold time sealing performance is good comprises:
a step of comparing an absolute value of the cold time pressure reduction rate with a first threshold, determining that the cold time sealing performance is good when the absolute value of the cold time pressure reduction rate is equal to or less than the first threshold, and determining that the cold time sealing performance is poor when the absolute value of the cold time pressure reduction rate is greater than the first threshold, and
the step of determining whether the hot time sealing performance is good comprises:
a step of comparing an absolute value of the hot time pressure reduction rate with a second threshold, determining that the hot time sealing performance is good when the absolute value of the hot time pressure reduction rate is equal to or less than the second threshold, and determining that the hot time sealing performance is poor when the absolute value of the hot time pressure reduction rate is greater than the second threshold,
the second threshold being greater than the first threshold.

5. The inspection method for the casting mold according to claim 2, wherein
the step of acquiring the cold time pressure reduction rate comprises:
a step of measuring a pressure in the gas flow path after a predetermined time has elapsed since the supply of the air is stopped when the casting mold is cold; and
a step of calculating the cold time pressure reduction rate based on a difference between the predetermined pressure and the pressure measured when the casting mold is cold.

6. The inspection method for the casting mold according to claim 2, wherein
the step of acquiring the hot time pressure reduction rate comprises:
a step of measuring a pressure in the gas flow path after a predetermined time has elapsed since the supply of the air is stopped when the casting mold is hot; and
a step of calculating the hot time pressure reduction rate based on a difference between the predetermined pressure and the pressure measured when the casting mold is hot.

7. A casting device comprising:
a casting mold including a cavity portion, a gas flow path including a first end which is one end connected to the cavity portion, and a shut-off valve configured to allow the gas flow path to be blocked;
an air supply unit configured to supply air having a predetermined pressure into the gas flow path from a second end which is another end of the gas flow path; and
a control unit configured to control the air supply unit and the shut-off valve, wherein
when the casting mold is cold, the control unit controls the shut-off valve and the air supply unit to supply the air having the predetermined pressure into the gas flow path from the second end of the gas flow path while the shut-off valve is closed and thereafter stop supply of the air, acquires a cold time pressure reduction rate of the air in the gas flow path after the supply of the air is stopped when the casting mold is cold, and determines whether a cold time sealing performance of the shut-off valve is good, based on the cold time pressure reduction rate.

8. The casting device according to claim 7, wherein
when the casting mold is hot, the control unit controls the shut-off valve and the air supply unit to supply the air having the predetermined pressure into the gas flow path from the second end of the gas flow path while the shut-off valve is closed, and thereafter stop supply of the air, acquires a hot time pressure reduction rate of the air in the gas flow path after the supply of the air is stopped when the casting mold is hot, and determines whether a hot time sealing performance of the shut-off valve is good, based on the hot time pressure reduction rate.

9. The casting device according to claim 8, wherein
when determining whether the cold time sealing performance is good, the control unit compares an absolute value of the cold time pressure reduction rate with a first threshold, and determines that the cold time sealing performance is good when the absolute value of the cold time pressure reduction rate is equal to or less than the first threshold, and determines that the cold time sealing performance is poor when the absolute value of the cold time pressure reduction rate is greater than the first threshold, and
when determining whether the hot time sealing performance is good, the control unit compares an absolute value of the hot time pressure reduction rate with a second threshold, and determines that the hot time sealing performance is good when the absolute value of the hot time pressure reduction rate is equal to or less than the second threshold, and determines that the hot time sealing performance is poor when the absolute value of the hot time pressure reduction rate is greater than the second threshold,
the second threshold being greater than the first threshold.
